(19) United States
(12) Patent Application Publication
(10) Pub. No.: US 2015/0319165 A1
(43) Pub. Date: Nov. 5, 2015

(54) ASSISTED AUTHENTICATION USING ONE-TIME-PASSCODE

(71) Applicant: HOIP TELECOM LIMITED, Awbridge, Romsey Hampshire (GB)

(72) Inventor: Andrew James MARSH, Whitenap, Romsey Hampshire (GB)

(73) Assignee: HOIP TELECOM LIMITED, Awbridge, Romsey Hampshire (GB)

(21) Appl. No.: 14/649,358

(22) PCT Filed: Dec. 2, 2013
(86) PCT No.: PCT/EP2013/075249

§ 371 Date: Jun. 3, 2015

(30) Foreign Application Priority Data
Dec. 3, 2012 (FI) 20126262

(51) Int. Cl. H04L 29/06; G06F 21/34; G06F 21/46; G06F 21/31

(52) U.S. Cl. CPC H04L 63/0838; H04L 63/0853; G06F 21/31; G06F 21/34; G06F 21/46

(57) ABSTRACT

An authentication method implemented on a server for authenticating a user device in a network comprising user devices and a server associated with a resource to be accessed. The server is configured to receive a request for access to a resource from a first user device and identify an entity to be authenticated from the request. A rule information set specifying how to form a one-time-passcode from a random code is defined and the random code is provided to a first device associated with the identified entity. A rule information set is provided to a second device associated with the identified entity and a one-time-passcode from the second device generated from the random code using at least one rule information set and received at the server.

### FIELD OF THE INVENTION

The present invention relates to authenticating a user accessing a protected resource, and more specifically to a method, an apparatus and a computer program product, as defined in the preambles of the independent claims.

### BACKGROUND OF THE INVENTION

Due to the broad use of computer and mobile networks in accessing private information and executing secure transactions there is a need to authenticate the users as reliably as possible. Delivering instant remote access is not just about remote employees. It is about enabling customers to perform online transactions, mobile sales personnel to access various applications, outsourced call centers to share the customer database, and more. Ensuring reliable, instantaneous access and the need to guard against breaches and ensure continuous governance is a must. For example, companies face security breach threads constantly and end users and eventually credit card companies suffer significant losses due to failures in the authentication phase in a financial transaction.

Some authentication solutions require longer and more complex passwords which in practice drives users to write the passwords down somewhere generating a security risk. Some solutions utilizing multiple factors of identification before gaining access to a workstation or network device are based on using a token or other hardware device providing one time passcodes. In case the separate device is lost some third party might get access to the passcodes listed on or sent to the device. All these solutions have challenges in security and/or convenience of use. Separately or in addition some solutions use encryption of the passwords sent which does not solve the problems described above.

### Brief Description of the Invention

The object of the present invention is to solve or alleviate at least part of the above mentioned problems. The objects of the present invention are achieved with a method, an apparatus and a computer program product according to the characterizing portions of the independent claims.

The preferred embodiments of the invention are disclosed in the dependent claims.

The present invention is based on a new method of authentication a user utilizing a one-time-passcode generated from a random code. An object of the present invention is to improve the authentication by increasing security and convenience by combining “something the user has” with “something the user knows”.

### BRIEF DESCRIPTION OF THE FIGURES

In the following the invention will be described in greater detail, in connection with preferred embodiments, with reference to the attached drawings, in which

FIG. 1 illustrates the functional elements of the present invention;

FIG. 2 illustrates a simplified block diagram of an authentication server;

FIG. 3 further illustrates the authentication server;

FIG. 4 is a sequence diagram displaying authentication flow and

FIG. 5 illustrates an embodiment of a system and how a one-time-passcode is generated.

### DETAILED DESCRIPTION OF SOME EMBODIMENTS

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a system architecture in which various embodiments of the invention may be implemented. Only elements relevant for illustrating the embodiments are described in detail. Various implementations of computer implemented processes, apparatuses and computer program products comprise elements that are generally known to a person skilled in the art and may not be specifically described herein.

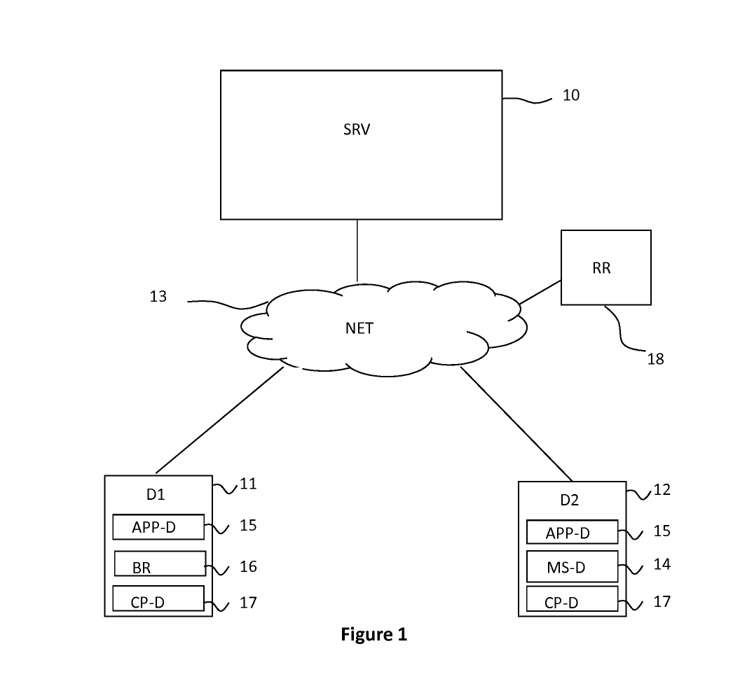

FIG. 1 illustrates an exemplary network system in which an embodiment of the present invention may be implemented. The shown network system comprises two user devices (D1) 11 and (D2) 12 connected to a network (NET) 13, and an authentication server (SRV) 10.

The network 13 represents here any combination of hardware and software components that enables a process in one communication endpoint to send or receive information to or from another process in another, remote communication endpoint. The network 13 may be, for example, a personal area network, a local area network, a home network, a storage area network, a campus network, a backbone network, a cellular network, a metropolitan area network, a wide area network, an enterprise private network, a virtual private network, a private or public cloud or an internetwork, or a combination of any of these.

At least one of the user devices 11, 12 comprises a device application (APP-D), 15. The device application 15 is a user controllable application that is, or may be stored in a memory of a user device 11 or 12 and provides instructions that, when executed by a processor unit (CP-D) 17 of the user device 11 or 12 perform the functions described herein. The expression “user-controlled” means that the user device 11 or 12 in which the application is executed comprises a user interface and the user may control execution of the application by means of the user interface. The user may thus initiate and terminate running of the application, provide commands that control the order of instructions being processed in the user device 11 or 12. The user devices 11 and 12 may be for example a laptop, desktop computer, graphics tablet, cellular phone, vehicle, door lock system, home controlling/monitoring unit etc. The user devices 11 and 12 may be associated to a same entity, for example the user device 11 being a laptop and the user device 12 being a cellular phone of a same user.

The at least one of the user devices 11, 12 comprises also a browser (BR) 16 accessible to the user via the device application 15. The user may thus apply the browser 16 to communicate with the authentication server 10 connected to the network 13. The at least one of the user devices 11, 12 comprises also a messaging application (MS-D) 14 for sending and receiving messages. The browser 16 and the messaging application 14 may also exist together in either or both of the user devices 11 and 12. The messaging application 14 may utilize Short Message Service, Multimedia Messaging Service, e-mail, Instant Messages, push notifications etc.

The authentication server 10 may be a web server that has an IP address and a domain name. The authentication server 10 may also be implemented as a cloud providing functions of the web server. The system also comprises a remote resource (RR) 18, which can be a web site, a database, service etc. In respect to the present invention “remote resource” may also be a local protected resource in or connected to user device 11 or 12.

Embodiments of this invention may be implemented with the authentication server 10 described in FIG. 1.

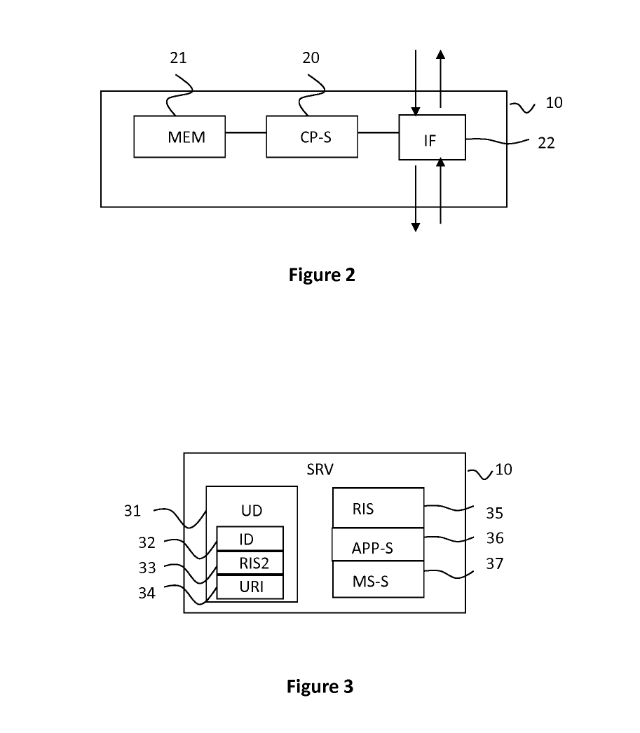

FIG. 2 shows a block diagram illustrating configuration of an example of the authentication server 10 for the purpose.

The authentication server 10 comprises a processor unit (CP-S) 20 for performing systematic execution of operations upon data. The processor unit 20 is an element that essentially comprises one or more arithmetic logic units, a number of special registers and control circuits. Memory unit (MEM) 21 provides a data medium where computer-readable data or programs, or user data can be stored. The memory unit is connected to the processor unit 20. The memory unit 21 may comprise volatile or non-volatile memory, for example EEPROM, ROM, PROM, RAM, DRAM, SRAM, firmware, programmable logic, etc.

The authentication server 10 may comprise an interface unit (IF) 22 with at least one input unit for inputting data to the internal processes of the authentication server 10 and at least one output unit for outputting data from the internal processes of the authentication server 10. The interface unit 10 of the authentication server 10 may also comprise means for network connectivity. If a line interface is applied, the interface unit 22 typically comprises plug-in units acting as a gateway for information delivered to its external connection points and for information fed to the lines connected to its external connection points. If a radio interface is applied, interface unit 22 typically comprises a radio transceiver unit, which includes a transmitter and a receiver, and is also electrically connected to the processing unit 20. The transmitter of the radio transceiver unit receives a bit stream from the processing unit 20, and converts it to a radio signal for transmission by the antenna.

The processor unit 20, the memory unit 21, and the interface unit 22 are electrically interconnected to provide means for systematic execution of operations on received and/or stored data according to predefined, essentially programmed processes of the authentication server 10. These operations comprise the means, functions and procedures described herein for the authentication server 10. The units may exist in one physical element or be networked for distributed operations.

FIG. 3 further illustrates a block diagram of the authentication server 10. User database (UD) 31 includes information about the registered entities. The information may include entity identification and contact information (ID) 32, user specific rule information sets (RIS2) 33 and location information (URI) 34 relating to the remote resources. The authentication server 10 also includes a rule information set (RIS) 35 and a messaging application (MS-S) 37 for sending and receiving messages. The authentication server 10 also comprises a server application (APP-S) 36. The server application 36 may be stored in a memory unit 21 of the authentication server 10 and provides instructions that, when executed by a processor unit 20 of the authentication server 10, perform the functions described herein. The entity identification and contact information (ID) 32 may include any device specific identifier of the user devices 11 or 12, like processor id, mac-address etc. and contact information of a user, like phone number, e-mail address, instant messaging account name etc.

In general, various embodiments of the authentication server 10 may be implemented in hardware or special purpose circuits, software, logic or any combination thereof. Some aspects may be implemented in hardware, while some other aspects may be implemented in firmware or software, which may be executed by a controller, microprocessor or other computing apparatus. Software routines, which are also called as program products, are articles of manufacture and can be stored in any device-readable data storage medium and they include program instructions to perform particular tasks.

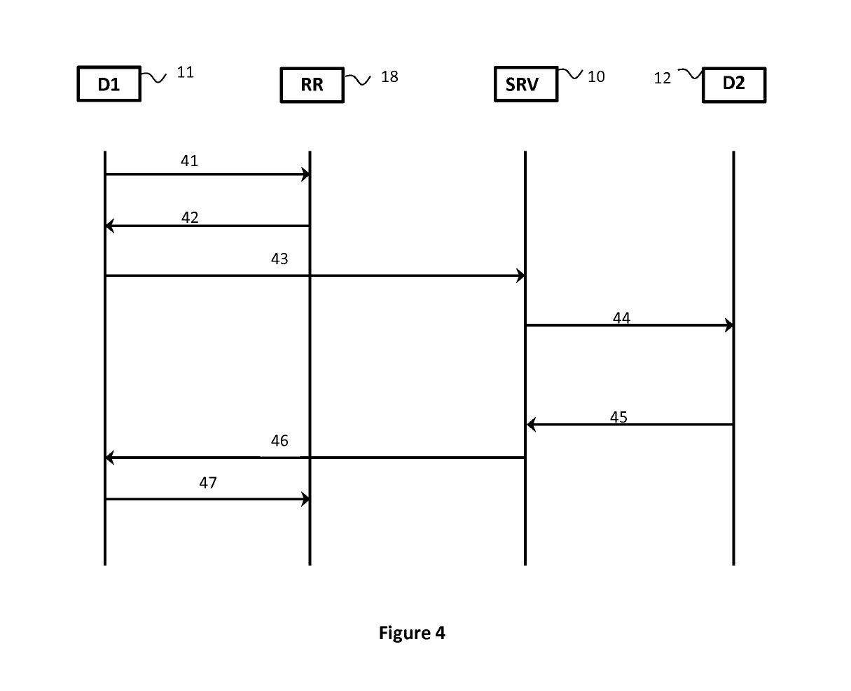

The flow chart of FIG. 4 illustrates an embodiment of an authentication dialog flow according to the invention. In the beginning, an entity wishes to access a remote resource 18 (step 41) with a user device 11. The remote resource 18 requires an authentication, and the user device 11 is redirected to an authentication dialog (step 42). A request for authentication together with identification information of the entity is sent to the authentication server 10 (step 43) from the user device 11. At the authentication server 10 the identification information is checked using the entity identification and contact information ID 32 and a random code with a number of characters is generated. A random code for generating a one-time-passcode is provided to the user device 11 (step 44) from the authentication server 10. A message is sent by the authentication server 10 to the user device 12 (step 45) with information about selected digits from the random code using rule information set RIS 35 for generating a one-time-passcode. A reply message from the user device 12 is sent to the authentication server 10 (step 46) with a one-time-passcode derived from the random code using the rule information set 35. The number of attempts for sending the one-time-passcode may be limited. Finally—if the one-time-passcode was accepted at the authentication server 10—information with approval is provided to the user device 11 (step 47) and the entity using the user device 11 is redirected to the remote resource 18 using location information URI 34. Validity of the authentication may be limited for example based on time or number of transactions etc. Another rule information set 33, specified for a user, can be used, too. In that case the one-time-passcode is derived from the random code by using the both rule information sets 33 and 35. The authentication messaging may be based for example on an OAuth 2.0 dialog. The OAuth 2.0 authorization framework enables a third-party application to obtain limited access to an HTTP service, either on behalf of a resource owner by orchestrating an approval interaction between the resource owner and the HTTP service, or by allowing the third-party application to obtain access on its own behalf.

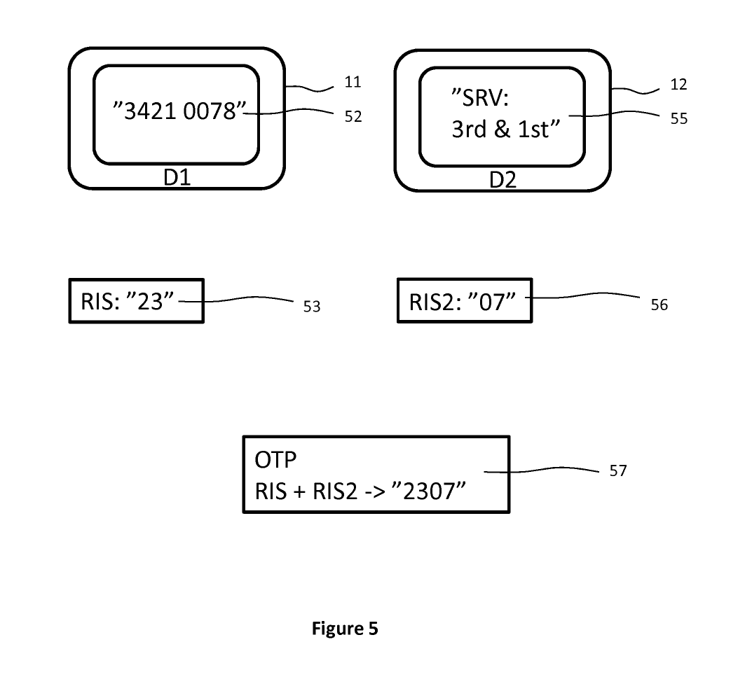

FIG. 5 illustrates in a simplified manner user device 11 and user device 12. The strings displayed in quotes e.g. “3421 0078” 52 on the user interface displays are for illustrative use only and it needs to be understood that the individual characters may be any unit of information including letters, numbers, punctuation marks, or other symbols used in computing (e.g. ″, #, *,% . . . ). Also the number of characters is not limited to what is illustrated in FIG. 5 as well as the format or contents of the messages. In respect to present invention a “random code” can also be a randomly selected code from a large enough selection of pre-defined codes. First string “3421 0078” 52 is shown on user device shown the other way around: the first string “3421 0078” 52 on user device 12 and the second string “SRV: 3^{rd} & 1^{st}” 55 on user device 11. The random code may be displayed and valid only for a limited time e.g. for one minute. First string “3421 0078” 52 is an example of a random code, second string “SRV: 3^{rd} & 1^{st}” 55 is an example of a message describing a selection of the random code string “3421 0078” 52 utilizing rule information set 35. Third string “23” 53 is an example of a selection from the random code string “3421 0078” 52 using information from the second string “SRV: 3^{rd} & 1^{st}”. Fourth string “07” 56 is an example of a selection from the random code string “3421 0078” 52 using a second rule information set 33. In this example a one-time-passcode OTP string “2307” 57 is generated by using both selection strings 53 and 56.

While various aspects of the invention have been illustrated and described as block diagrams, message flow diagrams, or using some other pictorial representation, it is well understood that the illustrated units, blocks, device, system elements, procedures and methods may be implemented in, for example, hardware, software, firmware, special purpose circuits or logic, a computing device or some combination thereof.

It is assumed that the user to be authenticated has to be registered at the authentication server 10. Identification may be based on entity identification or contact information 32. Identification of the entity to be authenticated may be based on the user device 11 using a device specific identification code, client software, location of the device or other means. Identification may be based on user specific information, for example login name or e-mail address of the user. Also an identification of the user device 12 may be required at the authentication server 10 before the one-time-passcode is accepted. The identification may be based on any unchangeable identifier of the user device 12 such as processor id. Also a subscriber identification module, SIM, can be used.

One part of the registration is to define a user specific rule information set 33. This rule set defines how the authentication server 10 is pre-defined to accept a selection of digits of a random code 52 for a one-time-passcode 57. The options for defining a rule information set are unlimited. For example the options may include:
Direction how the authentication server 10 reads the random code 52
Direction how the user reads the random code 52
Number of digits selected by the authentication server 10
Number of digits selected by the user
Position of digits the user selects
How to combine the selections by the authentication server 10 and the user

Another part of the registration is to define information how to reach the remote resource 18 after a successful authentication. The information may be a uniform resource identifier URI. URI is a string of characters used to identify a name or a resource. Such identification enables interaction with representations of the resource over a network (typically the World Wide Web) using specific protocols.

When the authentication server 10 identifies a registered entity accessing a remote resource the authentication process can be started. A server specific rule information set 35 may be randomly selected for each authentication request at the authentication server 10.

Let us consider an example of an authentication flow, where the authentication service is running on an authentication server 10. A user wishes to access a company intranet in www.thecompanyxyz.com. The company uses mobile assisted authentication service to which the user is registered with all the needed information like user ID, personal contact information, personal rule information set 33 and an URI where the user is directed after a successful authentication. The user connects to the internet with a personal computer, opens a browser and goes to www.thecompanyxyz.com/sign-in and types in a login name.

Since the site is using mobile assisted authentication the user is directed to https://maa-authorize.me/authorize? and a random code is shown on the display, e.g. “3421 0078” 52. Using a rule information set 35 at the authentication server 10 the authentication service selects two digits from the random code 52. Next the authentication server 10 sends a message to the user's personal user device 12 disclosing information about the rule information set 35 which was used at the authentication server 10. The message says “Message from The Company XYZ: MAA server has selected digits in following positions: 3^{rd} and 1^{st}”. (=“23” 53 in this example). Next, using his or hers personal secret information rule set 33, the user picks other two digits from the random code “3421 0078” 52 and combines those with the digits derived from the message received from the authentication server 10. In the registration phase the user has set the personal rule information 33 set as:
read the random code from left to right,
select 6^{th} and 7^{th} digits (=“07” 56 in this example) and
combine selections from the server first followed by the own selection (=“2307” 57 in this example).

The user replies with a message with the one-time-passcode “2307” 57 in the message body to the authentication server 10. If the one-time-passcode is correct the authentication server 10 finalizes the authentication and directs the user to the remote resource 18.

The embodiments of the present invention described above enable clear improvement in authenticating the user by combining the security of two-factor authentication with the convenience and simplicity of mobile devices and SMS messages. A number of significant benefits are achieved:
Improved security: it delivers two-factor authentication that offers a number of security advantages over basic user name and password access, helping provide a strong layer of protection for user access and identities.
Reduced security costs: compared to hardware-based token approaches, it provides both significant up front savings—by reducing token purchases and distribution costs- and over the long term by streamlining administration and eliminating the cost of replacing lost tokens.
Boost deployment opportunities: By eliminating tokens from the equation and relying instead on ubiquitous mobile devices, it brings two-factor authentication to a range of arenas where it would have been previously impractical—online banking, controlled access to valuable IP, e-learning education portals, authenticating voice-based system access, healthcare sites.

It is apparent to a person skilled in the art that as technology advances, the basic idea of the invention can be implemented in various ways. The invention and its embodiments are therefore not restricted to the above examples, but they may vary within the scope of the claims.

1.-15. (canceled)

16. Method for authentication of a user device in a network comprising user devices and a server associated with a resource to be accessed, the method comprising the following steps performed by the server
receiving a request for access to a resource from a first user device,
identifying an entity to be authenticated from the request,
defining at least one rule information set specifying how to form a one-time-passcode from a random code,
providing the random code to a first device associated with the identified entity,
providing a rule information set to a second device associated with the identified entity, and
receiving a one-time-passcode from the second device generated from the random code using at least one rule information set.

17. The authentication method of claim 16, wherein a second rule information set is defined for the second device.

18. The authentication method of claim 17, wherein the one-time-passcode is generated from the random code using the rule information set provided to the second device and the second rule information set defined for the second device.

19. The authentication method of claim 16, wherein the random code comprises characters, e.g. letters, digits and punctuation marks.

20. The authentication method of claim 16, wherein at least one rule information set includes information about which characters to be used in generating the one-time-passcode.

21. The authentication method of claim 16, wherein at least one rule information set include information in which order the characters to be used in generating an authentication code.

22. The authentication method of claim 16, wherein the random code provided to the first device is displayed for a limited time.

23. The authentication method of claim 16, wherein the server accepts the one-time-passcode only if the second device is identified.

24. The authentication method of claim 16, wherein the authentication is valid for a predefined time or for one transaction.

25. A server for authenticating a user device in a network comprising user devices and a resource to be accessed, the authentication server being configured to
receive a request for access to a resource from a first user device,
identify an entity to be authenticated from the request,
define at least one rule information set specifying how to form a one-time-passcode from a random code,
provide the random code to a first device associated with the identified entity,
provide a rule information set to a second device associated with the identified entity, and
receive a one-time-passcode from the second device generated from the random code using at least one rule information set.

26. A server according to claim 25, wherein the server is configured to receive a second rule information set defined for the second device.

27. A server according to claim 26, wherein the server is configured to receive a one-time-passcode generated from the random code using the rule information set provided to the second device and the second rule information set defined for the second device.

28. A server according to claim 25, wherein the server is configured to define at least one rule information set including information about which characters to be used in generating the one-time-passcode.

29. A server according to claim 25, wherein the server is configured to accept the one-time-passcode only if the second device is identified.

30. A computer program product, embodied on a non-transitory computer readable medium, and encoding instructions for executing the method of
receiving a request for access to a resource from a first user device,
identifying an entity to be authenticated from the request,
defining at least one rule information set specifying how to form a one-time-passcode from a random code,
providing the random code to a first device associated with the identified entity,
providing a rule information set to a second device associated with the identified entity, and
receiving a one-time-passcode from the second device generated from the random code using at least one rule information set.
